(19) United States
(12) Patent Application Publication
(10) Pub. No.: US 2013/0036722 A1
(43) Pub. Date: Feb. 14, 2013

(54) FUEL SYSTEM HAVING FUEL CONTROL UNIT AND HEAT EXCHANGER

(71) Applicants: Behzad Hashenas, San Diego, CA (US); David Lloyd Ripley, San Diego, CA (US); Ayman Battikha, San Diego, CA (US)

(72) Inventors: Behzad Hashenas, San Diego, CA (US); David Lloyd Ripley, San Diego, CA (US); Ayman Battikha, San Diego, CA (US)

(21) Appl. No.: 13/208,899

(22) Filed: Aug. 12, 2011

(51) Int. Cl. F02C 7/16; F02C 7/12

(52) U.S. Cl. 60/39.83; 137/339

(57) ABSTRACT

A fuel system includes a fuel control unit having a fuel passage that extends between an inlet to at least one pump stage and an outlet at a metering valve that is operable to control fuel supply. A portion of the fuel passage extends through a heat exchanger.

### BACKGROUND

This disclosure relates to fuel systems, such as a system to deliver fuel to an auxiliary power unit used in an aircraft.

Turbomachines are known and used to transfer energy between a rotor and a fluid. One example turbomachine is an auxiliary power unit (APU), which is typically mounted in the tail section of a commercial aircraft. The APU provides electrical power and compressed air to the aircraft. A fuel control unit delivers desired fuel quantities to the APU.

### SUMMARY

Disclosed is a fuel system that includes a fuel control unit that has a fuel passage that extends between an inlet to at least one pump stage and an outlet at a metering valve that is operable to control fuel supply. A portion of the fuel passage extends through a heat exchanger.

In another aspect, an example fuel system also includes a turbomachine having a lubrication system with a lubrication passage. A portion of the fuel passage and a portion of the lubrication passage extend through the heat exchanger to transfer heat there between.

The various features and advantages of the disclosed examples will become apparent to those skilled in the art from the following detailed description. The drawings that accompany the detailed description can be briefly described as follows.

### BRIEF DESCRIPTION OF THE DRAWINGS

FIG. 1 schematically illustrates an example fuel system that includes a fuel control unit and a heat exchanger.

FIG. 2 schematically illustrates another embodiment of a fuel system.

FIG. 3 schematically illustrates another embodiment of a fuel system.

FIG. 4 schematically illustrates another embodiment of a fuel system.

### DETAILED DESCRIPTION

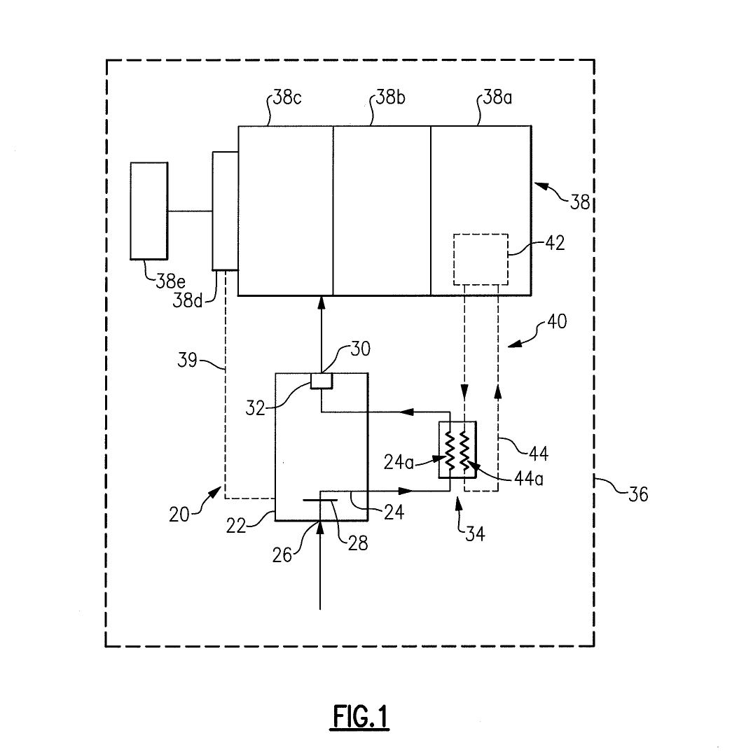

FIG. 1 schematically illustrates an example fuel system 20. The exemplary fuel system 20 is shown within an end use environment of a schematically illustrated aircraft 36, although it is to be understood that the fuel system 20 is not limited to such an application.

The fuel system 20 includes a fuel control unit 22 and a heat exchanger 34. In the implementation shown, the fuel system 20 can be considered to also include a turbomachine 38 to which the fuel control unit 22 delivers the fuel. However, the inclusion of the turbomachine 38 in the fuel system 20 is optional. As will be described in further detail below, the heat exchanger 34 increases the temperature of fuel flowing through the fuel system 20 to eliminate the ice crystals in cold fuel, for example.

The fuel control unit 22 includes a fuel passage 24 for transporting fuel. The fuel passage 24 runs between an inlet 26 to a pump stage 28 of the fuel control unit 22 and an outlet 30. A pump stage is a portion that increases the pressure of the fuel. The outlet 30 is located at the discharge of a metering valve 32, such as a solenoid, that is operable to control fuel supply from the fuel control unit 22. A portion 24a of the fuel passage 24 extends through the heat exchanger 34.

In this example, the turbomachine 38 includes a compressor section 38a, a combustion section 38b and a turbine section 38c (shown schematically) that cooperate to compress air, combust the pressurized air and expand the combustion products. The turbomachine 38 also includes a gearbox 38d through which a generator 38e is mechanically driven in response to rotation of the compressor section 38a and turbine section 38b. In this example, the fuel control unit 22 is driven from the gearbox 38d. For instance, the pump stage 28 is a shaft-driven pump that is coupled (represented at 39) to be driven by the turbomachine 38 through the gearbox 38d. In other examples, the fuel control unit 22 is not coupled to the gearbox 38d and instead is electrically or hydraulically driven. It is to be understood that this is an example of the turbomachine 38 and that the turbomachine 38 is not limited to the illustrated arrangement.

In the operating environment of the aircraft 36, the turbomachine 38 is used as an auxiliary power unit (APU) that is located in a tail section of the aircraft 36. The aircraft 36 includes one or more engines for propulsion and the APU is therefore a secondary source of power that is not used for propulsion. The APU is enclosed within the airframe structure of the aircraft 36 and receives air from an inlet that is typically located on the top portion of the tail section.

The turbomachine 38 includes a lubrication system 40 to lubricate and cool moving components. The lubrication system 40 includes a sump 42 and a lubrication passage 44 for circulating oil or other lubricant through the lubrication system 40. A portion 44a of the lubrication passage 44 extends through the heat exchanger 34 for thermal transfer with the portion 24a of the fuel passage 24. In embodiments that do not include the turbomachine 38 or lubrication system 40, the heat exchanger 34 utilizes another source of thermal energy for transfer with the fuel passage 24.

The thermal transfer serves to heat fuel flowing through the fuel passage 24. The increase in the temperature of the fuel can be used to eliminate the ice crystals in cold fuel. If ice crystals remain, the ice crystals could foul the fuel system 20 or other turbomachine 38 fuel system components and prevent proper operation.

The design of the heat exchanger 34 is not limited to any particular type. In some examples, the heat exchanger 34 can be a counter-flow design, parallel or cross-flow design, tube/fin design, plate/fin design, micro-channel design or the like. Given this description, one of ordinary skill in the art will recognize suitable heat exchanger designs to meet their particular needs.

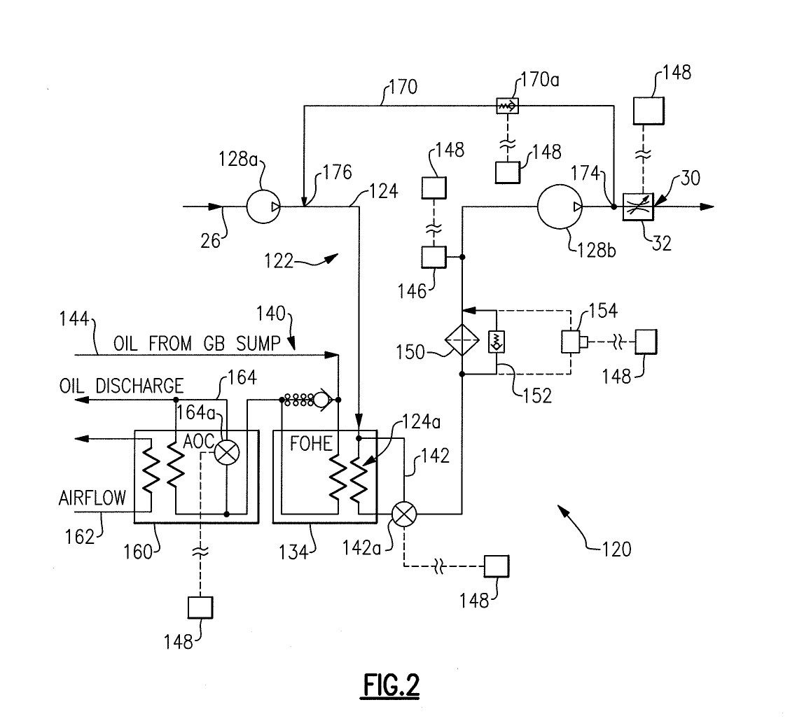

FIG. 2 shows another embodiment fuel system 120. In this disclosure, like reference numerals designate like elements where appropriate and reference numerals with the addition of one-hundred or multiples thereof designate modified elements that are understood to incorporate the same features and benefits of the corresponding elements.

In this example, the fuel system 120 includes a fuel control unit 122 having a fuel passage 124 that runs between the inlet 26 to an initial low pressure pump stage 128a and the outlet 30 at the metering valve 32. The fuel passage 124 also extends through a final high pressure pump stage 128b. The pump stages 128a, 128b progressively pressurize the fuel flowing through the fuel passage 124. The fuel control unit 122 can optionally include additional pump stages between the initial pump stage 128a and the final pump stage 128b.

A portion 124a of the fuel passage 124 extends through a heat exchanger 134. The portion 124a is located between the initial pump stage 128a and the final pump stage 128b. In other examples, the portion 124a can be located between any two pump stages in the fuel control unit 122.

In this example, the fuel passage 124 also includes a bypass passage 142. The bypass passage 142 includes a valve 142a that is operable to control flow through the bypass passage 142. That is, the valve 142a is selectively operated to either allow fuel flow through the heat exchanger 134 or through the bypass passage 142 (avoiding flow through the heat exchanger 134), depending upon the temperature of the fuel. In that regard, the fuel system 120 also includes a temperature sensor 146 located downstream from heat exchanger 134 to detect the fuel temperature. The valve 142a can be an electrically actuated valve that, in addition to the temperature sensor 146, is in communication with a controller 148.

The controller 148 is operable to control the valve 142a in response to temperature signals received from the temperature sensor 146. Thus, if the temperature of the fuel is above a predetermined threshold temperature, the controller 148 commands the valve 142a to open the bypass passage 142 such that fuel bypasses the heat exchanger 134 through the bypass passage 142. Alternatively, if the temperature of the fuel is below the predetermined threshold temperature, the controller 148 commands the valve 142a to close the bypass passage 142 such that fuel flows through the heat exchanger 134 and is heated by a lubrication system 140. In embodiments, the valve 142a is a thermally actuated valve that actuates automatically based on the fuel discharge temperature from the heat exchanger 34. Thus, if the heat exchanger discharge fuel temperature is above a predetermined threshold temperature, the valve 142a will open the bypass passage 142 such that fuel bypasses the heat exchanger 134 through the bypass passage 142. Alternatively, if the temperature of the fuel is below the predetermined threshold temperature, the valve 142a will close the bypass passage 142 such that fuel flows through the heat exchanger 134 and is heated by a lubrication system 140.

In this embodiment, the metering valve 32 is also in communication with the controller 148 to control the metering of fuel from the fuel control unit 122. In one example, the controller 148 controls fuel flow from the fuel control unit 122 through the metering valve 32 in response to the temperature signals from the temperature sensor 146. Thus, the fuel control unit 122 can account for temperature variations in the fuel to deliver precise amounts of fuel during start-up, full speed operation and under various load demands, and also potentially detect improper function of the heat exchanger 134/valve 142a.

The fuel system 120 optionally also includes a fuel filter 150 for removing particles or other undesired substances from the fuel prior to fuel reaching the high pressure pump stage 128b. A filter bypass passage 152 and a bypass sensor 154 are available for selectively bypassing the fuel filter 150. The bypass sensor 154 is also in communication with the controller 148.

In the illustrated example, the lubrication system 140 includes an air-oil heat exchanger 160 located downstream from the heat exchanger 134 with regard to oil flow through the lubrication passage 144. The air-oil heat exchanger 160 includes an air flow passage 162 for heat exchange with the lubrication passage 144.

In one embodiment, the air-oil heat exchanger 160 includes a bypass passage 164 and a valve 164a within the bypass passage 164 that is operable to control oil flow through the bypass passage. In one example, the valve 164a is electrically driven and in communication with the controller 148. The controller 148 is operable to control the valve 164a in response to the temperature of the oil, for example. Depending on the temperature, the controller 148 opens or closes the bypass passage 164 to divert oil flow around or through the air-oil heat exchanger 160. In one example, the valve 164a is a thermally actuated valve that actuates automatically according to the oil temperature. Depending on the oil temperature, the valve 164a opens or closes the bypass passage 164 to divert oil flow around or through the air-oil heat exchanger 160. In one example, the air-oil heat exchanger 160 can be made to be relatively small, and thus save weight, because of reduced cooling demands from the transfer of heat from the oil to the fuel.

The fuel system 120 further includes a fuel recirculation passage 170 for recirculating fuel back through at least a portion of the fuel control unit 122. In the illustrated example, the recirculation passage 170 includes a pressure actuated valve 170a. The recirculation passage 170 extends between an inlet 174 and an outlet 176. In this example, the inlet 174 is located downstream from the final pump stage 128b and upstream of the metering valve 32. The outlet 176 is located between the initial pump stage 128a and the final pump stage 128b, and upstream from the heat exchanger 134.

The recirculation passage 170 serves to recirculate the excess fuel back through the fuel passage 124 such that the fuel will again flow through the heat exchanger 134. In one embodiment, the ability to heat the fuel using the heat exchanger 134 avoids the use of external electrical or pneumatic heaters and can also reduce pump size where the pump is oversized with flow capacities much larger than the demand flow where the large volumes of excess flow recirculates back into the pump inlet to heat the fuel through much higher overpumping. The reduction in pump size also increases system efficiency and overheating the fuel that can otherwise occur at high altitude.

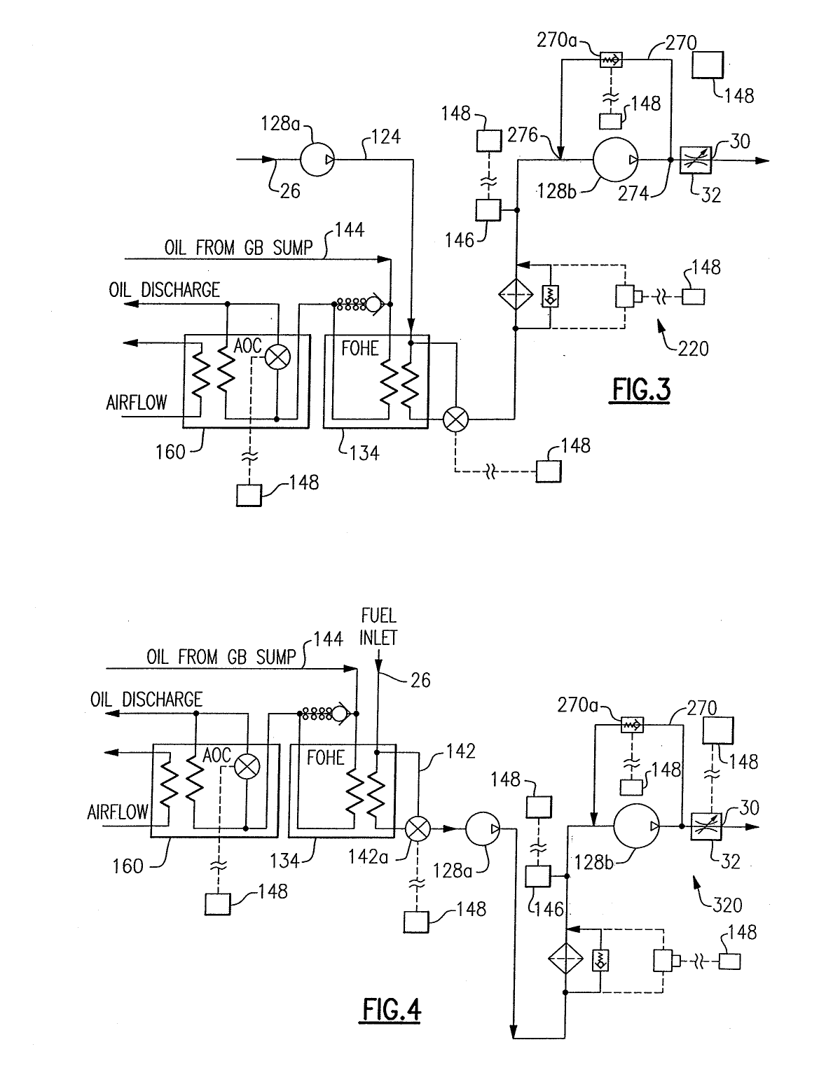

FIG. 3 shows another embodiment fuel system 220 that is similar to the fuel system 120 except that it includes a modified recirculation passage 270. In this example, the recirculation passage 270 includes a valve 270a. The recirculation passage 270 extends between an inlet 274 and an outlet 276. In this example, the inlet 274 is also located downstream from the final pump stage 128b and upstream of the metering valve 32. The outlet 276 is located between the initial pump stage 128a and the final pump stage 128b, and downstream from the heat exchanger 134. Thus, the recirculation passage 270 serves to recirculate fuel back through to the final pump stage 128b but not the heat exchanger 134. In this case, heat from the final pump stage 128b is used to increase the temperature of the fuel rather than the heat exchanger 134.

FIG. 4 shows another embodiment fuel system 320 that is similar to the fuel system 220 except that the heat exchanger 134 is located upstream from the initial pump stage 128a instead of between pump stages.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A fuel system comprising:
a fuel control unit including a fuel passage extending between an inlet to at least one pump stage and an outlet at a metering valve that is operable to control fuel supply; and
a heat exchanger through which a portion of the fuel passage extends.

2. The fuel system as recited in claim 1, wherein the portion of the fuel passage is between two pump stages of the fuel control unit.

3. The fuel system as recited in claim 2, including a fuel recirculation passage having an inlet located downstream from the two pump stages with respect to fuel flow through the fuel passage and an outlet located upstream from the heat exchanger.

4. The fuel system as recited in claim 1, wherein the fuel passage includes a temperature sensor located downstream from the heat exchanger.

5. The fuel system as recited in claim 4, including a controller in communication with the temperature sensor and the metering valve, the controller being operable to control the metering valve in response to temperature signals from the temperature sensor.

6. The fuel system as recited in claim 5, wherein the controller is operable to detect latent failures of the heat exchanger or a bypass valve associated with the heat exchanger in response to temperature signals from the temperature sensor.

7. The fuel system as recited in claim 1, including a bypass passage having an inlet located upstream from the heat exchanger relative to fuel flow through the fuel passage and an outlet located downstream from the heat exchanger, the bypass passage including a valve that is operable to control flow through the bypass passage.

8. The fuel system as recited in claim 1, wherein the portion is located between the inlet and an initial pump stage of the fuel control unit.

9. The fuel system as recited in claim 1, including a fuel recirculation passage having an inlet located downstream from a final pump stage with regard to fuel flow through the fuel passage and an outlet located upstream from the final pump stage and downstream of the heat exchanger.

10. The fuel system as recited in claim 1, wherein the fuel passage extends through a fuel filter.

11. The fuel system as recited in claim 1, including a lubrication passage of a turbomachine lubrication system, the lubrication passage extending through the heat exchanger to transfer heat between the lubrication passage and the fuel passage.

12. A fuel system comprising:
a turbomachine including a lubrication system having a lubrication passage;
a fuel control unit including a fuel passage extending between an inlet to at least one pump stage and an outlet at a metering valve that is operable to control fuel supply to the turbomachine; and
a heat exchanger through which a portion of the fuel passage and a portion of the lubrication passage extend to transfer heat there between.

13. The fuel system as recited in claim 12, wherein the turbomachine is an auxiliary power unit configured for an aircraft.

14. The fuel system as recited in claim 12, including a bypass passage having an inlet located upstream from the heat exchanger relative to fuel flow through the fuel passage and an outlet located downstream from the heat exchanger, the bypass passage including a valve that is operable to control flow through the bypass passage.

15. The fuel system as recited in claim 12, wherein the lubrication system includes an air-oil cooler located downstream from the heat exchanger relative to oil flow through the lubrication passage.

16. The fuel system as recited in claim 15, including a bypass passage having an inlet located upstream of the air-oil cooler and an outlet located downstream from the air-oil cooler, and the bypass passage includes a valve that is operable to control flow through the bypass passage.
